(19) United States
(12) Patent Application Publication
(10) Pub. No.: US 2015/0310826 A1
(43) Pub. Date: Oct. 29, 2015

(54) DISPLAY DEVICE AND PHOTOTHERAPY METHOD USING THE SAME

(71) Applicants: Samsung Display Co., Ltd., Yongin-City (KR); ACT CO., LTD., Chungcheongbuk-do (KR)

(72) Inventors: Min Gyeong JO, Busan (KR); Hak Sun KIM, Seoul (KR); Won Sang Park, Yongin-si (KR); Jong In Baek, Suwon-si (KR); Si-Jun Park, Yongin-si (KR); Bo-Seaub Lee, Yongin-si (KR); Dae-Sung Yoo, Chuncheon-si (KR)

(21) Appl. No.: 14/515,703

(22) Filed: Oct. 16, 2014

(30) Foreign Application Priority Data
Apr. 29, 2014 (KR) 10-2014-0051893

(51) Int. Cl. G09G 5/02; G09G 3/32; G09G 5/18

(52) U.S. Cl. CPC G09G 5/02; G09G 5/18; G09G 3/3208; G09G 2300/0426

(57) ABSTRACT

Provided is a display device having a phototherapy function. The display device includes a substrate, and a display unit formed on the substrate and including a red pixel, a green pixel, and a blue pixel. The red pixel emits red light having a peak wavelength of 628 nm to 638 nm. A full width at half maximum of red light may be 1 nm or more and 40 nm or less.

### CROSS-REFERENCE TO RELATED APPLICATION

This application claims priority to and the benefit of Korean Patent Application No. 10-2014-0051893 filed in the Korean Intellectual Property Office on Apr. 29, 2014, the entire contents of which are incorporated herein by reference.

### BACKGROUND

(a) Field

The present disclosure relates to a display device and a phototherapy method using the same.

(b) Description of the Related Art

A light emitting diode (LED) or an organic light emitting diode (OLED) may be used as a phototherapy device. Phototherapy is a technology where light with a predetermined wavelength which has a therapeutic effect is irradiated onto a portion of a therapy target, e.g., a person, for a predetermined time. Phototherapy may be applied to various fields such as injury therapy, a pimple, psoriasis, whitening, and wrinkle therapy.

The above information disclosed in this Background section is only for enhancement of understanding of the background of the disclosure and therefore it may contain information that does not form the prior art that is already known to a person of ordinary skill in the art.

### SUMMARY OF THE INVENTION

The present disclosure has been made in an effort to provide a display device allowing a user to easily undergo phototherapy regardless of time and a place by providing all of a display function and a phototherapy function in one device, and a phototherapy method using the same.

In one aspect, a display device includes a substrate; and a display unit formed on the substrate and including a red pixel, a green pixel, and a blue pixel. The red pixel may emit red light having a peak wavelength of 628 nm to 638 nm.

A full width at half maximum of the red light may be 1 nm or more and 40 nm or less.

The display device may further include a controller configured to supply a driving signal to the display unit, in which the controller may have a mode change function configured to select any one of a display mode and a phototherapy mode. When the display mode is selected, the driving signal may be supplied to the red pixel, the green pixel, and the blue pixel, and when the phototherapy mode is selected, the driving signal may be supplied to only the red pixel.

The controller may be configured to calculate a required use time corresponding to a recommended daily allowance of light exposure when the phototherapy mode is selected, and compare the required use time and an actual use time and if the actual use time satisfies the required use time, automatically finish the phototherapy mode. The controller may be configured to inform a user of a residual use time corresponding to a difference between the required use time and the actual use time in a voice information or visual information form.

Each of the red pixel, the green pixel, and the blue pixel may include a thin film transistor formed on the substrate; a pixel electrode connected to the thin film transistor; a light emitting layer formed on the pixel electrode; and a common electrode formed on the light emitting layer.

The pixel electrode may be formed of a metal reflection layer and the common electrode may be formed of a transflective layer to form a resonance structure. The pixel electrode may be formed of a double layer of the metal reflection layer and a transparent conductive layer. A capping layer may be formed on the common electrode.

On the other hand, the pixel electrode may be formed of the double layer of the transparent conductive layer and the transflective layer and the common electrode may be formed of the metal reflection layer to form the resonance structure.

In another aspect, a phototherapy method includes exposing a portion of skin cells to red light by using the display device, the display device including a red pixel emitting red light having a peak wavelength of 628 nm to 638 nm. The intensity of red light may be 1 μW/cm² or more and 100 μW/cm² or less.

A display device of the present example embodiments has a basic display function and a phototherapy function. Accordingly, a user may easily use the phototherapy function even with only selecting a phototherapy mode without purchasing a separate phototherapy device. Further, the display device of the present example embodiments may be attached to a mobile electronic device, and in this case, the user may use the phototherapy function during movement.

### BRIEF DESCRIPTION OF THE DRAWINGS

FIG. 1 is a schematic diagram of a display device according to a first example embodiment.

FIG. 2 is a schematic diagram illustrating a phototherapy mode of display device.

FIG. 3 is a flowchart illustrating an operation process of a controller of the display device illustrated in FIG. 1.

FIG. 4 is an expanded cross-sectional view schematically illustrating a display device according to a second example embodiment.

FIG. 5 is a schematic diagram illustrating an organic light emitting diode of a red pixel of the display device illustrated in FIG. 4.

FIG. 6 is a graph illustrating a spectrum of red light emitted by the red pixel in the display device of the second example embodiment.

FIG. 7 is a schematic diagram illustrating an organic light emitting diode of a red pixel of a display device according to a third example embodiment.

FIG. 8 is a graph illustrating a spectrum of red light emitted by the red pixel in the display device of the third example embodiment.

FIG. 9 is a schematic diagram illustrating an organic light emitting diode of a red pixel of a display device according to a fourth example embodiment.

FIG. 10 is a graph illustrating a spectrum of red light emitted by the red pixel in the display device of the fourth example embodiment.

FIG. 11 is an expanded cross-sectional view illustrating an organic light emitting diode of a red pixel of a display device according to a fifth example embodiment.

FIG. 12 is a graph illustrating a spectrum of red light emitted by the red pixel in the display device of the fifth example embodiment.

### DETAILED DESCRIPTION OF THE EMBODIMENTS

The present disclosure will be described more fully hereinafter with reference to the accompanying drawings, in which example embodiments are shown. As those skilled in the art would realize, the described embodiments may be modified in various different ways, all without departing from the spirit or scope of the present disclosure.

It will be understood that when an element such as a layer, film, region, or substrate is referred to as being “on” another element, it can be “directly on” the other element, or intervening elements may also be present. In addition, the word “on” means positioning on or below the object portion, but does not necessarily mean positioning on the upper side of the object portion based on a gravity direction.

Throughout the specification, unless explicitly described to the contrary, the word “comprise” and variations such as “comprises” or “comprising”, will be understood to imply the further inclusion of other elements. Further, in the specification, the phrase “in plan view” means when an object portion is viewed from the above, and the phrase “in cross section” means when a cross section taken by vertically cutting an object portion is viewed from the side.

In the drawings, the thickness of layers and regions is exaggerated for clarity, and for understanding and ease of description, the thickness of some layers and regions is exaggerated. In addition, the size and thickness of each configuration shown in the drawings are arbitrarily shown for understanding and ease of description, but the present disclosure is not limited thereto.

A general phototherapy device has at least one type of light source emitting light having a predetermined wavelength. The phototherapy device may turn on one type of light source to emit light having the predetermined wavelength to the portion of the therapy target, or may simultaneously turn on two or more types of light sources to simultaneously emit light having two different wavelengths to the portion of the therapy target. For example, a visible light having a predetermined wavelength and an infrared ray may be simultaneously emitted.

However, phototherapy devices in the related art can be difficult for individuals to purchase due to costs. Therefore, phototherapy devices are mainly installed in special therapy facilities such as hospitals, which can limit accessibility by potential users. Further, in the case of the therapy facilities such as the hospitals, there are various inconveniences such as a need for a separate space in order to install the phototherapy device and necessity for an additional time for therapy by the user.

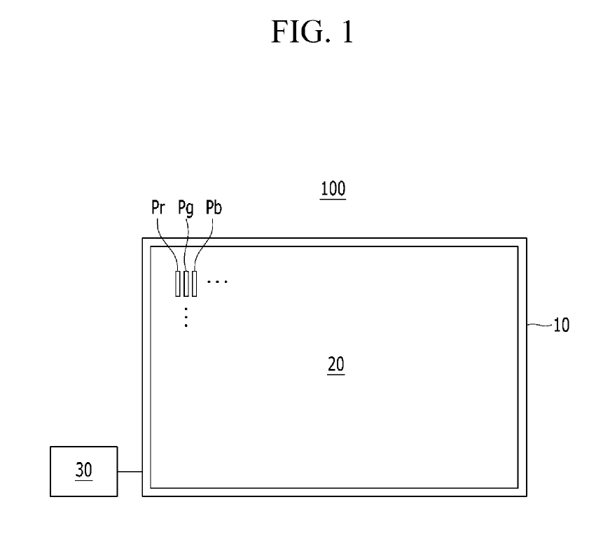

FIG. 1 is a schematic diagram of a display device according to a first example embodiment.

Referring to FIG. 1, a display device 100 includes a substrate 10, and a display unit 20 formed on the substrate 10. The display device may be an organic light emitting display or a liquid crystal display.

The substrate 10 may be a hard substrate such as glass or a flexible substrate that is bendable. The display unit 20 is formed on an upper surface of the substrate 10, and in plan view, includes a plurality of pixels Pr, Pg, and Pb arranged in a matrix form. Each pixel includes a red pixel Pr emitting red light, a green pixel Pg emitting green light, and a blue pixel Pb emitting blue light. That is, each of the red pixel Pr, the green pixel Pg, and the blue pixel Pb serves as a sub-pixel.

The term ‘display unit’ as used in the present specification means a device that includes a portion emitting light and a driving portion for adjusting the intensity of the light. The term “organic light emitting display” is a collective name for an organic light emitting diode (OLED) and a thin film transistor (TFT) array for driving the OLED. A detailed structure of the display unit 20 will be described below.

The red pixel Pr of the display unit 20 emits red light having a peak wavelength of 628 nm to 638 nm. Red light having the peak wavelength of 628 nm to 638 nm emitted by the red pixel Pr has a phototherapy effect such as, for example, anti-inflammation, whitening, and wrinkle improvement. A full width at half maximum (FWHM) of the red light may be 1 nm or more and 40 nm or less, and when this condition is satisfied, the intensity of the red light may be increased. A detailed structure of the red pixel Pr for implementing red light having the aforementioned peak wavelength and full width at half maximum will be described below.

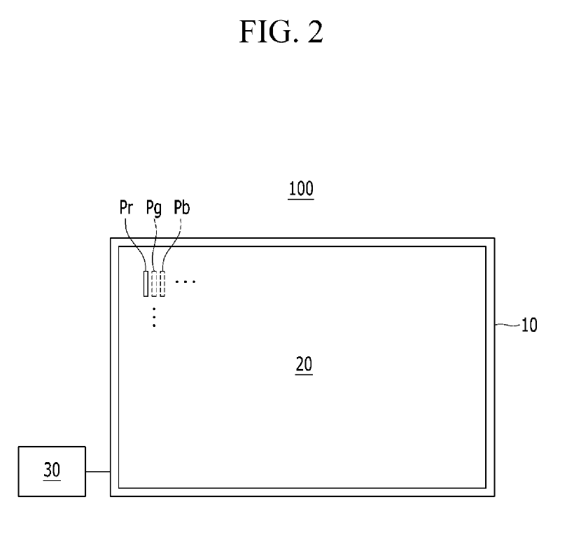

The display unit 20 is connected to a controller 30, and the display device 100 may drive all of the red pixel Pr, the green pixel Pg, and the blue pixel Pb to selectively implement a display mode displaying a predetermined screen image and a phototherapy mode driving only the red pixel Pr. The display device 100 of FIG. 1 is in the display mode, and FIG. 2 is a schematic diagram illustrating the phototherapy mode of display device 100.

Referring to FIGS. 1 and 2, the controller 30 supplies electric signals required for the red, green, and blue pixels Pr, Pg, and Pb to emit light to the display unit 20, and has a mode change function that allows a user to select a mode. The controller 30 supplies a driving signal to the red, green, and blue pixels Pr, Pg, and Pb when the display mode is selected, and supplies the driving signal to only the red pixel Pr when the phototherapy mode is selected. Accordingly, the display unit 20 may implement either the display mode or the phototherapy mode depending upon the signal received from the controller 30.

The controller 30 may also have a function that calculates an amount of time corresponding to a recommended daily allowance of light exposure when the phototherapy mode is selected, and may inform the user of such required light irradiation time.

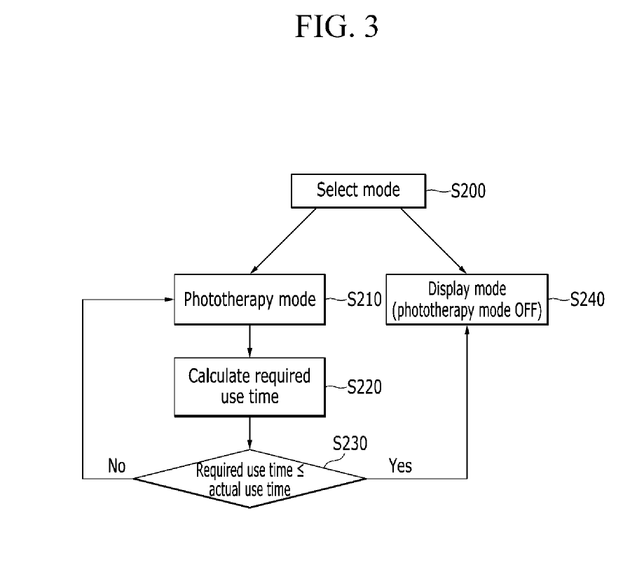

FIG. 3 is a flowchart illustrating an operation process for the controller of the display device illustrated in FIG. 1.

The operation process of the controller 30 is described with reference to FIG. 3. First, either the display mode or the phototherapy mode is selected (S200). If the phototherapy mode is selected, the controller 30 supplies the driving signal to only the red pixel to implement the phototherapy mode (S210) and may calculate a required use time (S220). In addition, the required use time and an actual use time (phototherapy mode operation time) are compared (S230), and if the actual use time satisfies the require use time, the phototherapy mode may be automatically finished (S240). For example, the phototherapy mode may be automatically stopped and be converted into the display mode.

The required use time of the phototherapy mode is based on the recommended daily allowance of exposure to the therapeutic light, and may be represented by the following Equation 1.

$$Required use time ( h ) = \frac{recommended daily dose ( h \times {µW}^{2} \text{/} {cm}^{2} )}{maximum output ( {µW}^{2} \text{/} {cm}^{2} )} \qquad ( Equation 1 )$$

where H refers to hour, μW refers to microwatt, and cm are centimeters.

Further, the controller 30 may include a function informing the user of a residual use time when the required use time is calculated. The residual use time may be implemented, for example, in a form of voice information using a speaker or visual information using the display unit 20.

The phototherapy method according to the present example embodiment utilizes the aforementioned display device 100, and includes exposing a portion of a therapy target, e.g., a portion of a person's or animal's skin, that needs to be treated to red light. The intensity of red light may be 1 μW/cm² or more and 100 μW/cm² or less, and when this condition is satisfied, wrinkle improvement, whitening, and anti-inflammation effects due to irradiation of red light may be obtained. Phototherapy effects using red light will be described below.

The display device of the present example embodiment has a basic display function and a phototherapy function, and thus the user may easily use the phototherapy function just by selecting the phototherapy mode without needing to purchase a separate phototherapy device. That is, the user may easily undergo phototherapy regardless of a place and a time. Further, the display device of the present example embodiment may be attached to a mobile electronic device, and in this case, the user may use the phototherapy function during movement.

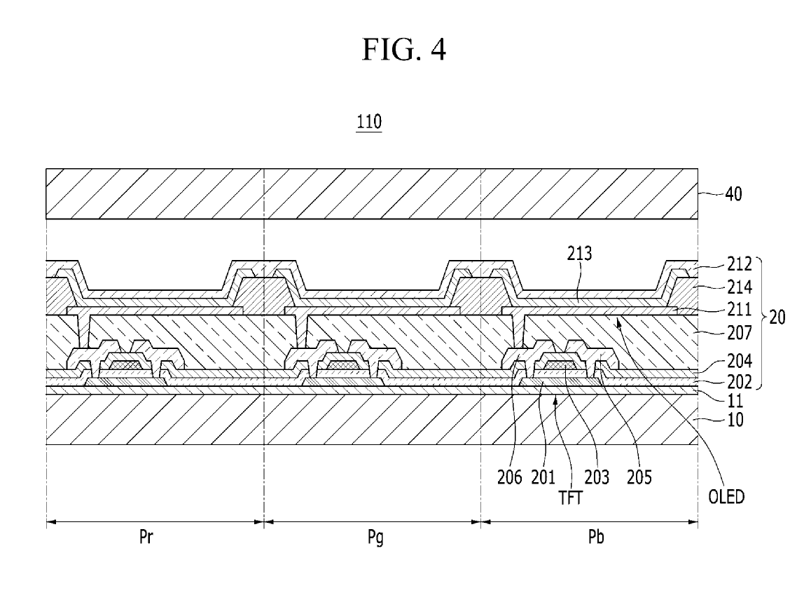

Hereinafter, the case where the display device of FIG. 1 is the organic light emitting display will be described in detail with reference to FIGS. 4 to 12.

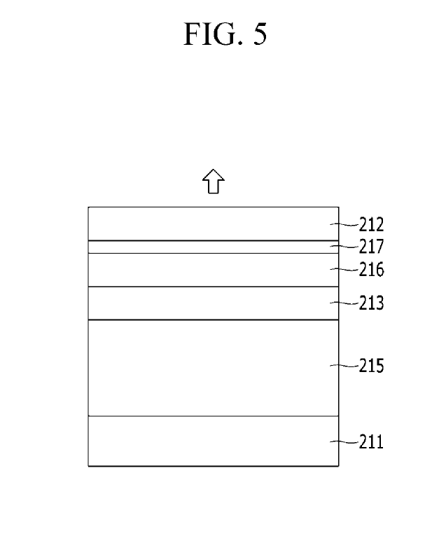

FIG. 4 is an expanded cross-sectional view schematically illustrating a display device 110 according to a second example embodiment, and FIG. 5 is a schematic diagram illustrating an organic light emitting diode of a red pixel of the display device illustrated in FIG. 4. A residual constitution, excluding the light emitting layer of the organic light emitting diode illustrated in FIG. 5 may be commonly applied to organic light emitting diodes of a green pixel and a blue pixel.

Referring to FIGS. 4 and 5, the display device 110 includes a substrate 10, a display unit 20 formed on the substrate 10, and a sealing member 40 covering the display unit 20 to seal the display unit 20.

The substrate 10 may be a hard substrate such as glass or metal, or a flexible substrate that is bendable. The flexible substrate may be formed of a plastic material having excellent heat resistance and durability, such as, for example, polyethylene terephthalate (PET), polyethylene naphthalate (PEN), polycarbonate (PC), polyarylate, polyetherimide (PEI), polyethersulfone (PES), and polyimide (PI).

The display unit 20 includes a red pixel Pr, a green pixel Pg, and a blue pixel Pb, and each of the red pixel Pr, the green pixel Pg, and the blue pixel Pb includes an organic light emitting diode (OLED) and a thin film transistor (TFT) array electrically connected to the organic light emitting diode (OLED). The thin film transistor array includes at least two thin film transistors, at least one capacitor, and wires. The wires include a scan line, a data line, and a driving voltage line.

For convenience of description, FIG. 4 schematically illustrates only the organic light emitting diode (OLED) and a driving thin film transistor (TFT) for each pixel Pr, Pg, and Pb. However, the display device of the present example embodiment is not limited to the illustrated example, and may further include two or more thin film transistors, two or more capacitors, and various types of wires.

A buffer layer 11 is formed on the substrate 10. The buffer layer 11 serves to increase smoothness of a surface and prevent impurity elements from permeating into the TFT and OLED. An active layer 201 is formed in a region corresponding to each pixel on the buffer layer 11. The active layer 201 may be formed of an inorganic semiconductor such as silicon or an oxide semiconductor, or an organic semiconductor. The active layer 201 includes a source region, a drain region, and a channel region therebetween.

A gate insulating layer 202 is formed on the active layer 201, and a gate electrode 203 is formed at a predetermined position on the gate insulating layer 202. An interlayer insulating layer 204 is formed on the gate insulating layer 202 and the gate electrode 203, and a source electrode 205 and a drain electrode 206 are formed on the interlayer insulating layer 204. The source electrode 205 and the drain electrode 206 come into contact with the source region and the drain region of the active layer 201 through contact holes of the interlayer insulating layer 204, respectively. The thin film transistor (TFT) is covered by a passivation layer 207 to be protected. FIG. 4 illustrates a thin film transistor (TFT) having a top gate structure as an example.

The organic light emitting diode (OLED) is formed in an emission region on the passivation layer 207. The organic light emitting diode (OLED) includes a pixel electrode 211, a common electrode 212, and a light emitting layer 213 positioned therebetween. Organic light emitting diodes (OLEDs) are classified into bottom emission type, top emission type, and double-sided emission type based on the light emitting direction of the OLED. In the present example embodiment, a description will be given based on the case where the organic light emitting diode (OLED) is of the top emission type, as indicated in FIG. 5.

The pixel electrode 211 is formed of a metal reflection layer. The pixel electrode 211 may include, for example, Ag, Mg, Al, Pt, Pd, Au, Ni, Nd, Ir, Cr, or a compound thereof. The pixel electrode 211 is formed of an island type positioned to correspond to a position within each of the red pixel Pr, the green pixel Pg, and the blue pixel Pb, and is connected to the drain electrode 206 of the driving thin film transistor (TFT). The pixel electrode 211 may serve as an anode providing a hole to the light emitting layer 213.

A pixel definition layer 214 covering an edge of the pixel electrode 211 is formed on the pixel electrode 211. In the pixel definition layer 214, an opening through which a central portion of the pixel electrode 211 is exposed is formed, and the light emitting layer 213 is formed in the opening.

The common electrode 212 is a transmissive electrode, and may be formed of a transflective layer obtained by thinly forming a metal having a small work function, such as Li, Ca, LiF/Ca, LiF/Al, Al, Mg, or Ag. The common electrode 212 is formed over the entire display unit 20 without distinction between the red pixel Pr, the green pixel Pg, and the blue pixel Pb, and is connected to a common voltage. The common electrode 212 may serve as a cathode providing electrons to the light emitting layer 213.

As illustrated in FIG. 5 for an organic light emitting diode of a red pixel in the display device, at least one of a hole injection layer and a hole transport layer 215 may be formed between the pixel electrode 211 and the light emitting layer 213, and at least one of an electron transport layer 216 and an electron injection layer 217 may be formed between the light emitting layer 213 and the common electrode 212. In the case where the light emitting layer 213 is formed of a polymer organic material, only the hole transport layer 215 may be positioned between the pixel electrode 211 and the light emitting layer 213.

The hole transport layer 215 is a layer for easily transferring the holes of the pixel electrode 211 to the light emitting layer 213, and is formed to be relatively thicker than other layers. The material used for the hole transport layer 215 is not particularly limited, and for example, a carbazole derivative such as N-phenylcarbazole and polyvinylcarbazole, 4,4′-bis[N-(1-naphthyl)-N-phenylamino]biphenyl(NPB), N,N′-bis(3-methylphenyl)-N,N′-diphenyl-[1,1-biphenyl]-4,4′-diamine (TPD), polyethylene dihydroxythiophene(poly-2,4-ethylene-dihydroxythiophene) (PEDOT), polyaniline, and the like may be used.

The light emitting layer 213 includes a host and a dopant. The dopant is a material emitting actually light, and the host is a material helping the dopant to have the highest light efficiency under a given condition. In the case of the red pixel Pr in which the light emitting layer 213 emits red light having a peak wavelength of 628 nm to 638 nm, tris(8-hydroquinolinato)aluminum (Alq₃) and the like may be used as the host for implementing the peak wavelength, and 4-(dicyanomethylene)-2-t-butyl-6-(1,1,7,7-tetramethyljulolidyl-9-enyl)-4H-pyran) (DCJTB) and the like may be used as the dopant.

The electron transport layer 216 is a layer for easily transferring the electrons of the common electrode 212 to the light emitting layer 213. The material of the electron transport layer 216 is not particularly limited, and for example, Alq₃, Li, Cs, Mg, LiF, CsF, MgF₂, NaF, KF, BaF₂, CaF₂, Li₂O, BaO, Cs₂CO₃, Cs₂O, CaO, MgO, lithium quinolate, and the like may be used.

The electron injection layer 217 is a layer allowing the electrons to be easily injected from the common electrode 212, and has a thickness that is very small as compared to other layers, and can be omitted if necessary. The material of the electron injection layer 217 is not particularly limited, and for example, LiF, LiQ, NaCl, NaQ, BaF, CsF, Li₂O, Al₂O₃, BaO, C₆₀, a mixture thereof, and the like may be used. On the other hand, the electron injection layer 217 may be formed of a double layer of a first layer including any one of LiF, LiQ, NaCl, NaQ, BaF, CsF, Li₂O, Al₂O₃, and BaO and a second layer including a metal such as Al.

The sealing member 40 may be sealed at an edge of the substrate 10 by a sealant (not illustrated), and may be formed of glass, quartz, ceramic, plastic, or the like. The sealing member 40 may be constituted by a thin film sealing layer obtained by depositing an inorganic layer and an organic layer several times directly on the common electrode 212. FIG. 4 illustrates a substrate type sealing member 40 as an example.

In the aforementioned display device 200, the organic light emitting diode (OLED) of the red pixel Pr emits red light having the peak wavelength of 628 nm to 638 nm, and the common electrode 212 is formed of the transflective layer of the metal, and thus red light causes strong resonance between the pixel electrode 211 and the common electrode 212.

Specifically, a distance between the pixel electrode 211 and the common electrode 212 satisfies a constructive interference condition of the wavelength of the emitted red light, and to this end, thicknesses of the layers positioned between the pixel electrode 211 and the common electrode 212 are appropriately adjusted. For example, the hole transport layer 215 may have a thickness of approximately 10 nm to 150 nm, and the common electrode 212 may have a thickness of approximately 10 nm to 150 nm. The intensity of red light is amplified by this strong resonance structure, and a full width at half maximum of 1 nm or more and 40 nm or less may be implemented.

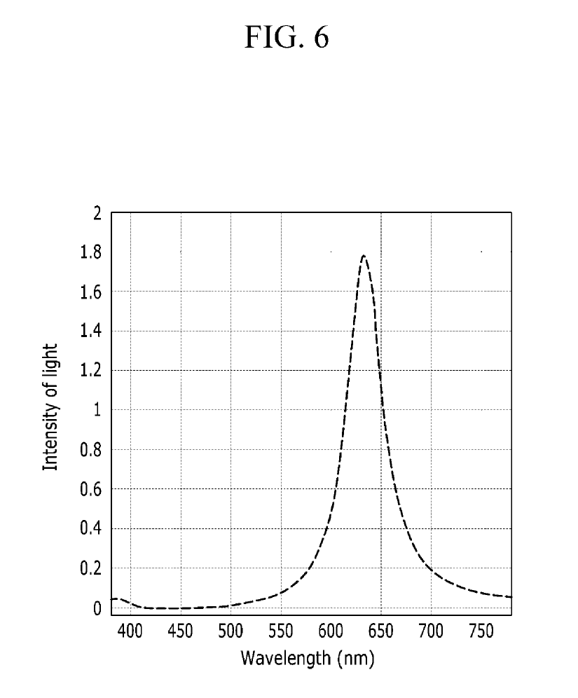

FIG. 6 is a graph illustrating a spectrum of red light emitted by the red pixel in the display device of the second example embodiment. The light intensity represented in a vertical axis of the graph is an arbitrary unit. In the graph of FIG. 6, the peak wavelength is 633 nm, and the full width at half maximum is 40 nm.

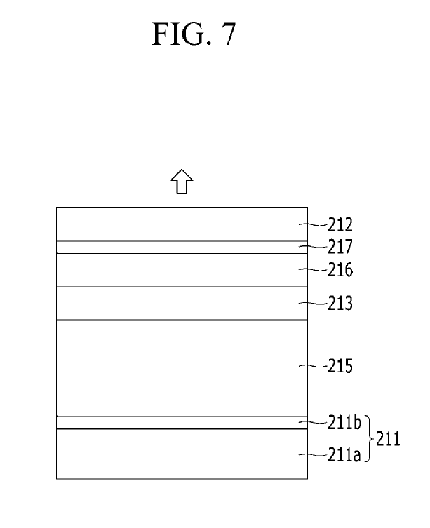

FIG. 7 is a schematic diagram illustrating an organic light emitting diode of a red pixel of a display device according to a third example embodiment.

Referring to FIG. 7, the display device of the third example embodiment has the same structure as the display device of the aforementioned second example embodiment, except that a pixel electrode 211 is constituted by a double layer of a metal layer 211a having high reflectance and a transparent conductive layer 211b. The same reference numerals are used for the same members as the second example embodiment, and a constitution that is different from that of the second example embodiment will be mainly described below.

The pixel electrode 211 may be formed of the double layer of the metal reflection layer 211a including silver (Ag) and the transparent conductive layer 211b including any one of ITO, IZO, ZnO, and In₂O₃. Silver (Ag) of the metal reflection layer 211a has high reflectance, and thus serves to increase a resonance peak and reduce a full width at half maximum.

The transparent conductive layer 211b covers the metal reflection layer 211a to prevent a short of the metal reflection layer 211a and an organic layer during a subsequent organic layer process, and the transparent conductive layer 211b itself may serve as a hole injection layer. Further, in view of hole injection, the transparent conductive layer 211b serves to reduce an energy barrier difference between the metal reflection layer 211a and a hole transport layer 215 and increase hole injection efficiency and light emitting efficiency due to a low work function.

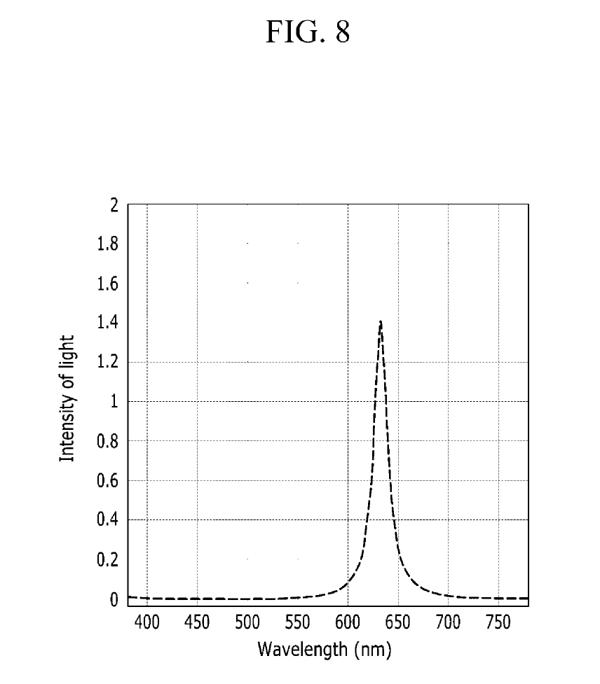

FIG. 8 is a graph illustrating a spectrum of red light emitted by the red pixel in the display device of the third example embodiment. The light intensity represented in a vertical axis of the graph is an arbitrary unit. In the graph of FIG. 8, a peak wavelength of red light is 633 nm, and the full width at half maximum is 15 nm.

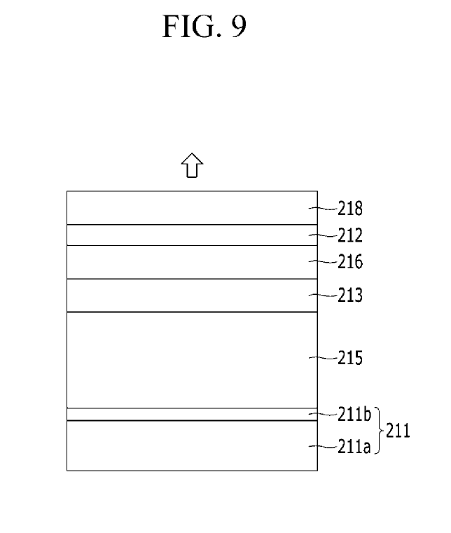

FIG. 9 is a schematic diagram illustrating an organic light emitting diode of a red pixel of a display device according to a fourth example embodiment.

Referring to FIG. 9, the display device of the fourth example embodiment has the same structure as the display device of the third example embodiment, except that an electron injection layer is omitted and a capping layer 218 is further formed on a common electrode 212. The same reference numerals are used for the same members as the third example embodiment, and a constitution that is different from that of the third example embodiment will be mainly described below.

If the capping layer 218 is positioned on the common electrode 212, light transmitted through the common electrode 212 passes through an additional interference path. That is, light reflected on an interfacial surface of the capping layer 218 and an external air layer is re-reflected on a surface of the common electrode 212 of a lower portion to be emitted to the outside. Accordingly, the capping layer 218 serves to reduce a quantity of light which is emitted from the common electrode 212 and totally reflected to be lost, and increase the quantity of transmitted light and thus increase light emitting efficiency.

The capping layer 218 may have a refractive index of approximately 1.7 to 2.4, and may include, for example, any one of a triamine derivative, an arylenediamine derivative, CBP (4,4′-N,N-dicarbozal-biphenyl), and Alq₃. Further, the capping layer 218 is linked with a resonance structure of the organic light emitting diode (OLED) to serve to reduce a full width at half maximum.

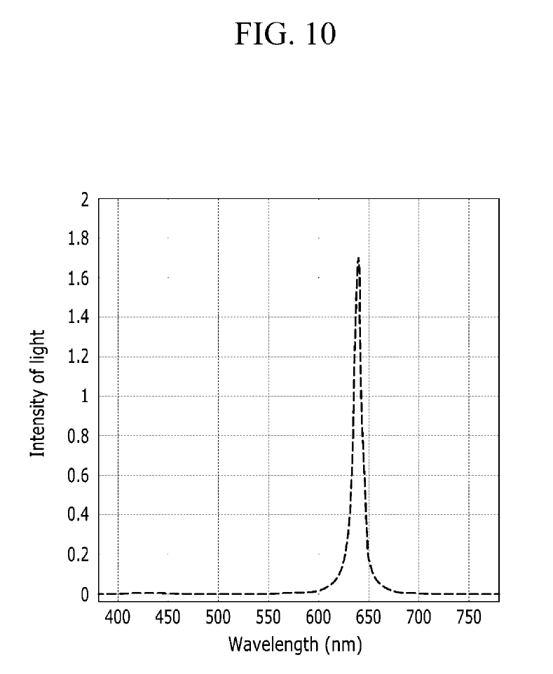

FIG. 10 is a graph illustrating a spectrum of red light emitted by the red pixel in the display device of the fourth example embodiment. The light intensity represented in a vertical axis of the graph is an arbitrary unit. In the graph of FIG. 10, a peak wavelength of red light is 633 nm, and the full width at half maximum is 9 nm.

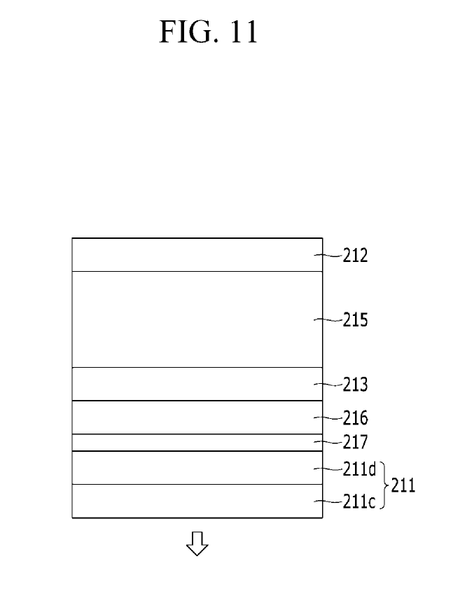

FIG. 11 is an expanded cross-sectional view illustrating an organic light emitting diode of a red pixel of a display device according to a fifth example embodiment.

Referring to FIG. 11, the display device of the fifth example embodiment has the same constitution as the display device of the aforementioned second example embodiment, except that the display device is of a bottom emission type. The same reference numerals are used for the same members as the second example embodiment, and a constitution that is different from that of the second example embodiment will be mainly described below.

A substrate is formed of a transparent material through which light is transmitted. A pixel electrode 211 is a transmissive electrode, and may be formed of a double layer of a transparent conductive layer 211c and a transflective layer 211d. The transparent conductive layer 211c may include, for example, any one of ITO, IZO, ZnO, and In₂O₃, and the transflective layer 211d may be formed of a metal having a small work function, such as Li, Ca, LiF/Ca, LiF/Al, Al, Mg, and Ag. The pixel electrode 211 may serve as a cathode injecting electrons into a light emitting layer 213.

A common electrode 212 is formed of a metal reflection layer, and may include, for example, Ag, Mg, Al, Pt, Pd, Au, Ni, Nd, Ir, Cr, or a compound thereof. The common electrode 212 may serve as an anode injecting holes into the light emitting layer 213. An electron injection layer 217 and an electron transport layer 216 may be formed between the pixel electrode 211 and the light emitting layer 213. A hole transport layer 215 may be formed between the light emitting layer 213 and the common electrode 212. Because materials of the electron injection layer 217, the electron transport layer 216, and the hole transport layer 215 are the same as materials mentioned in the second example embodiment, a detailed description thereof will be omitted.

The pixel electrode 211 is formed of a double layer of the transparent conductive layer 211c and the transflective layer 211d, and thus red light may (i) cause resonance between the pixel electrode 211 and the common electrode 212; (ii) amplify the intensity of light by a constructive interference, and (iii) implement a full width at half maximum of 1 nm or more and 40 nm or less.

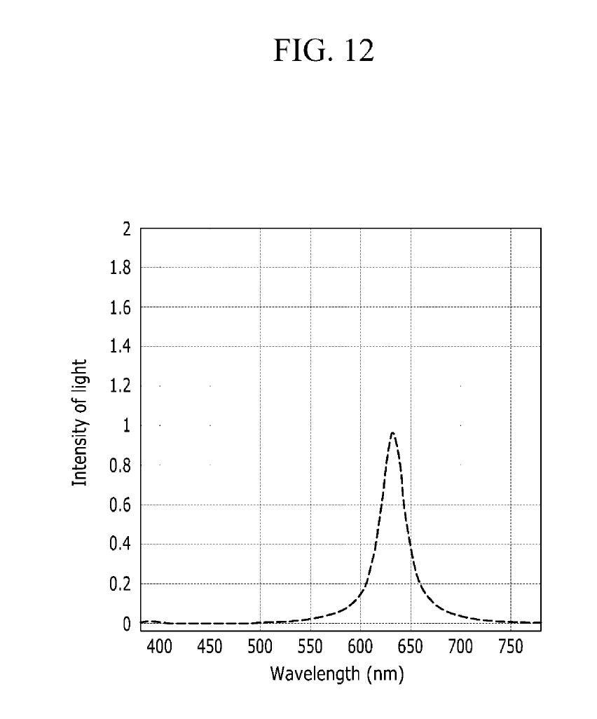

FIG. 12 is a graph illustrating a spectrum of red light emitted by the red pixel in the display device of the fifth example embodiment. The light intensity represented in a vertical axis of the graph is an arbitrary unit. In the graph of FIG. 12, a peak wavelength of red light is 633 nm, and the full width at half maximum is 22 nm.

Next, a phototherapy effect of the aforementioned display device will be described.

A person's skin is subjected to various physical and chemical changes in the aging process. The causes of aging are largely classified into intrinsic aging and photo-aging. Ultraviolet rays, stress, disease, environmental factors, and injury destroy an antioxidant defense film existing in a person's body, and damage cells and tissues, which promotes adult diseases and aging.

Major constituent materials of the skin include lipids, proteins, polysaccharides, hexanes, and the like, and if these materials are oxidized, collagen, hyaluronic acid, elastin, proteoglycan, and fibronectin that form the connective tissues of the skin are cut. In such cases, a hyper-inflammatory response may occur, and elasticity of the skin deteriorates. In severe cases, mutation, cancer, and a reduction in immunity function are caused due to modification of DNA.

Matrix metalloproteinase (MMP), which is a collagenase that that breaks the bonds in collagen, is involved in aging. As aging progresses, collagen synthesis is reduced and expression of the collagenase MMP is promoted, so that elasticity of the skin is reduced and wrinkles form. Further, expression of the MMP is activated by irradiation of ultraviolet rays.

The aforementioned display device has a cell regeneration effect (Experimental Example 1), a MMP-1,2 generation suppression effect (Experimental Example 2), a collagen synthesis improvement effect (Experimental Example 3), a melanin generation suppression effect to a B16F10 melanocyte (Experimental Example 4), a cytotoxicity relaxation effect by irradiation of ultraviolet rays (Experimental Example 5), and a proinflammatory cytokine expression suppression effect by irradiation of ultraviolet rays (Experimental Example 6).

### Experimental Example 1

### Cell Regeneration

On the 24-well plate, the HaCaT keratinocyte (German Cancer Research Institute, Germany) was inoculated into the DMEM (Dulbecco™ Modified Eagle′ Medium) to which the 10% FBS (fetal bovine serum) was added in the density of 2×10⁵ cells/well, and cultivated for one day in the humidified culture medium of 37° C. and 5% CO₂. After exchanging with the serum-free DMEM, red light was irradiated for three days in the culture medium in which the aforementioned display device was installed to perform cultivation. In order to perform the comparative experiment, red light having the similar wavelength was irradiated for three days to perform cultivation, and TGF-β (transforming growth factor beta) (10 ng/ml), which is the material known to have a cell regeneration effect, was used as the positive control group. Further, cultivation was performed for three days in the culture medium having no light irradiation function to use the resulting keratinocyte as the control group. The degrees of generation of the cell were compared and evaluated by using the MTT (Microculture Tetrazolium) assay method, and the experimental result is described in the following Table 1.

TABLE 1

| | | Absorbance |
|---|---|---|
| Classification | Note | (at 570 nm) |
| Example 1 | 628 nm to 639 nm (633 ± 5 nm) | 1.417 |
| Comparative | 615 nm to 625 nm (620 ± 5 nm) | 1.103 |
| Example 1 | | |
| Comparative | 635 nm to 640 nm (640 ± 5 nm) | 1.115 |
| Example 2 | | |
| Comparative | Positive control group | 1.423 |
| Example 3 | (TGF-β) | |
| Comparative | Control group | 0.921 |
| Example 4 | | |

In Example 1 and Comparative Examples 1 and 2 of Table 1, the intensity of the red light used was 47.5 μW/cm².

In general, regeneration of the skin cell is measured by the activation rate of the cell, and the activation rate of the cell is proportional to the absorbance (at 570 nm) in Table 1. It can be confirmed that in the phototherapy mode, the display device (Example 1) of the present Example implementing the peak wavelength of 628 nm to 638 nm has the higher cell regeneration effect as compared to the case where red light having the similar wavelength is used (Comparative Examples 1 and 2). Further, it can be confirmed that the effect of the display device of the present Example is not significantly reduced as compared to the result of the positive control group using TGF-β known to have the cell regeneration effect.

### Experimental Example 2

### Suppression of Generation of Collagenase MMP-12

The fibroblast (Korean Cell Line Bank, Korean) that was the human normal skin cell was inoculated on the 48-well microplate (Nunc™, Denmark) so that the number of cells was 1×10⁶ for each well, cultivated in the DMEM medium (Sigma™, USA) under the condition of 37° C. for 24 hours, and cultivated by irradiating red light for three days in the culture medium of Experimental Example 1. In order to perform the comparative experiment, red light having the similar wavelength was irradiated for three days to perform cultivation, and TGF-β (10 ng/ml) known to have the effect of suppressing generation of collagenase MMP-1,2 was used as the positive control group. Cultivation was further performed for 48 hours in the culture medium having no light irradiation function to use the resulting fibroblast as the control group.

After cultivation, the supernatant liquid of each well was collected to measure the amount (ng/ml) of newly synthesized MMP-1,2 by using the MMP-1,2 analysis kit (Amersham™, USA), the MMP generation suppression ratio (%) was calculated according to the following Equation 2, and the result is described in the following Table 2.

MMP generation rate(%)=(Amount of MMP of the experimental group/Amount of MMP of the control group)×100 (Equation 2)

TABLE 2

| | | MMP-1 | MMP-2 |
|---|---|---|---|
| | | generation | generation |
| | | suppression | suppression |
| Classification | Note | ratio (%) | ratio (%) |
| Example 2 | 628 nm to 639 nm | 73.1 | 78.2 |
| | (633 ± 5 nm) | | |
| Comparative | 615 nm to 625 nm | 69.4 | 68.1 |
| Example 5 | (620 ± 5 nm) | | |
| Comparative | 635 nm to 640 nm | 72.2 | 71.8 |
| Example 6 | (640 ± 5 nm) | | |
| Comparative | Positive control | 75.1 | 76.2 |
| Example 7 | group (TGF-β) | | |

In Example 2 and Comparative Examples 5 and 6 of Table 2, the intensity of of the red light used was 47.5 μW/cm².

It can be confirmed that the display device of the present Example (Example 2) has the higher MMP-1,2 generation suppression ratio as compared to the case where red light having the similar wavelength is used (Comparative Examples 5 and 6) and has the effect that is almost similar to that of the positive control group.

### Experimental Example 3

### Improvement of Synthesis of Collagen

The fibroblast that was the human normal epithelial cell was inoculated on the 48-well microplate so that the number of cells was 1×10⁶ for each well, cultivated in the DMEM medium for 24 hours, and cultivated by irradiating red light in a predetermined quantity for one day and three days in the culture medium of Experimental Example 1. In order to perform the comparative experiment, TGF-β (10 ng/ml) known to have the collagen synthesis improvement effect was used as the positive control group, and cultivation was further performed for 48 hours in the culture medium having no red light irradiation function to use the resulting fibroblast as the control group.

After cultivation, the supernatant liquid of each well was collected to measure the amount of procollagen type IC-peptide (PICP) by using the collagen kit (Takara™, Japan) and thus measure the amount of synthesized collagen. The collagen biosynthesis increase ratio (%) was calculated according to the following Equation 3, and the result is described in the following Table 3.

Collagen biosynthesis increase ratio(%)=(Amount of collagen of the experimental group/Amount of collagen of the experimental group)×100 (Equation 3)

TABLE 3

| | | Collagen biosynthesis |
|---|---|---|
| Classification | Note | increase ratio (%) |
| Example 3 | 628 nm to 639 nm (633 ± 5 nm) | 14.5 |
| | 24 hours | |
| Example 4 | 628 nm to 639 nm (633 ± 5 nm) | 28.5 |
| | 72 hours | |
| Comparative | Positive control group | 24.7 |
| Example 8 | (TGF-β) | |
| Comparative | Control group | 0 |
| Example 9 | | |

In Examples 3 and 4 of Table 3, the intensity of the red light used was 47.5 μW/cm².

In the case of Example 3 where red light was irradiated for 24 hours, the collagen biosynthesis ratio was measured to be 114.5%, and in the case of Example 4 where red light was irradiated for 72 hours, the collagen biosynthesis ratio was measured to be 128.5%. It can be confirmed that the display devices of the present Examples (Examples 3 and 4) have the collagen synthesis improvement effect, and Example 4 exhibits the higher effect as compared to the positive control group.

### Experimental Example 4

### Suppression of Generation of Melanin to the B16F10 Melanocyte

The B16F10 melanocyte is a cell strain derived from a mouse, and is a cell secreting a black pigment that is called melanin. The B16F10 melanocyte used in the present Experimental Example was distributed from ATCC (American Type Culture Collection™), and used.

The B16F10 melanocyte was divided in the 2×10⁶ concentration for each well on the 6-well plate, attached, and cultivated by irradiating red light in the culture medium of Experimental Example 1 for 72 hours. After cultivation for 72 hours, the cells were separated by trypsin-EDTA (ethylenediaminetetraacetic acid), the number of cells was measured, and centrifugation was performed to collect the cells. Quantification of melanin in the cell was performed by modifying the Lotan's method. After the cell pellet was washed by the PBS (phosphate buffer saline) once, 1 ml of homogenized buffer solution (50 mM sodium phosphate, pH 6.8, 1% Triton X-100, 2 mM PMSF (Phenylmethylsulfonyl fluoride)) was added, and swirling was performed for 5 minutes to break the cell. Melanin extracted by adding 1N NaOH (10% dimethyl sulfoxide (DMSO)) to the filtrate of the cell obtained by centrifugation was dissolved, absorbance of melanin was measured by the microplate reader at 405 nm, and melanin was quantified to measure the melanin generation hindrance ratio (%) of the sample. In order to perform the comparative experiment, hydroquinone and arbutin that are materials known to have a melanin generation suppression effect were used as the positive control groups.

The melanin generation hindrance ratio (%) of the B16F10 melanocyte was calculated by the following Equation 4, and the result is described in the following Table 4.

$$Melanin generation hindrance ratio = ( \frac{A - B )}{A} ) \times 100 \qquad ( Equation 4 )$$

Herein, A represents the amount of melanin of the well to which the sample is not added, and B represents the amount of melanin of the well to which the sample is added.

TABLE 4

| | | Melanin generation |
|---|---|---|
| Classification | Note | hindrance ratio (%) |
| Example 5 | 628 nm to 639 nm (633 ± 5 nm) | 61.6 |
| | 72 hours | |
| Comparative | Positive control group | 73.1 |
| Example 10 | (hydroquinone) | |
| Comparative | Positive control group | 52.3 |
| Example 11 | (arbutin) | |

In Example 5 of Table 4, the intensity of the red light used was 20 μW/cm².

The display device of the present Example (Example 5) has the lower melanin generation hindrance ratio as compared to the case of hydroquinone (Comparative Example 10) used as the positive control group, but has the higher melanin generation hindrance ratio as compared to the case of arbutin (Comparative Example 11) used as the other positive control group. As described above, it can be seen that the display device of the present Example largely hinders generation of melanin so as to have an excellent effect on skin whitening.

### Experimental Example 5

### Cytotoxicity Relaxation by Irradiation of Ultraviolet Rays

5×10⁴ fibroblasts were put at a time on the 24-well test plate, and attached for 24 hours. Each well was washed by the PBS once, and 1000 μl of the PBS was added to each well. After 10 mJ/cm² of ultraviolet rays were irradiated on the fibroblasts by using the ultraviolet ray B lamp, the PBS was taken out, and 1 ml of the cell cultivation medium (DMEM to which the 10% FBS was added) was added. Herein, red light was irradiated in the culture medium of Experimental Example 1 for 24 hours to perform cultivation. After cultivation for 24 hours, the medium was removed, 500 μl of the cell cultivation medium and 60 μl of the MTT solution (2.5 mg/ml) were put on each well, and cultivation was performed in the culture medium of 37° C. and CO₂ for 2 hours. The medium was removed, and iso-propanol-HCl (0.04 N) was put by 500 μl at a time. Shaking was performed for 5 minutes to dissolve the cells, the supernatant was moved to the 96-well test plate by 100 μl at a time, and absorbance at 565 nm was measured in the microplate reader.

The cell survival rate (%) was measured by the following Equation 5, and the cytotoxicity relaxation ratio (%) by irradiation of ultraviolet rays was calculated by the following Equation 6.

$$Cell survival rate ( \% ) = ( \frac{St - Bo}{Bt - Bo} ) \times 100 \qquad ( Equation 5 )$$

Herein, St represents absorbance of the well on which red light is irradiated, Bo represents absorbance of the cell cultivation medium, and Bt represents absorbance of the well on which red light is not irradiated.

$$Cytotoxicity relaxation ratio = ( 1 - \frac{St - Bo}{Bt - Bo} ) \times 100 \qquad ( Equation 6 )$$

Herein, St represents the cell survival rate of the well on which ultraviolet rays are irradiated and red light is irradiated, Bo represents the cell survival rate of the well on which the ultraviolet rays are not irradiated and red light is not irradiated, and Bt represents the cell survival rate of the well on which the ultraviolet rays are irradiated and red light is not irradiated.

The cytotoxicity relaxation ratio according to the intensity of red light is described in the following Table 5.

TABLE 5

| | | Cytotoxicity relaxation |
|---|---|---|
| Classification | Note | ratio (%) |
| Example 6 | 633 ± 5 nm/5 μW/cm² | 17.3 |
| Example 7 | 633 ± 5 nm/20 μW/cm² | 44.8 |
| Example 8 | 633 ± 5 nm/47.5 μW/cm² | 89.5 |

It can be confirmed that the display devices of the present Examples (Examples 6, 7, and 8) have the cytotoxicity relaxation effect by the ultraviolet rays and the cytotoxicity relaxation ratio is increased as the intensity of red light is increased.

### Experimental Example 6

### Suppression of Proinflammatory Cytokine Expression by Irradiation of Ultraviolet Rays

5×10⁴ keratinocytes separated from the human epidermal tissue were put at a time on the 24-well test plate, and attached for 24 hours. Each well was washed by the PBS once, and 500 μl of the PBS was put on each well. After 10 mJ/cm² of ultraviolet rays were irradiated on the keratinocytes by using the ultraviolet ray B lamp, the PBS was taken out, and 350 μl of the cell cultivation medium (DMEM to which the PBS was not added) was added. In addition, red light was irradiated in the culture medium of Experimental Example 1 for 72 hours to perform cultivation. 150 μl of cultivation supernatant was sampled to quantify proinflammatory cytokine (1L-1α) and thus judge the expression suppression effect of proinflammatory cytokine. The amount of proinflammatory cytokine was quantified by using the enzyme-linked immunosorbent assay, and ketoprofen known as the proinflammatory cytokine suppression material was used as the positive control group. The expression suppression ratio (%) of proinflammatory cytokine was calculated by the following Equation 7, and the result is described in the following Table 6.

(Equation 7)

Expression suppression ratio of

$$proinflammatory cytokine ( \% ) = ( 1 - \frac{St - Bo}{Bt - Bo} ) \times 100$$

Herein, St represents a proinflammatory cytokine generation amount of the well where the ultraviolet rays are irradiated thereon and the sample is treated, Bo represents the proinflammatory cytokine generation amount of the well where the ultraviolet rays are not irradiated thereon and the sample is not treated, and Bt represents the proinflammatory cytokine generation amount of the well where the ultraviolet rays are irradiated thereon and the sample is not treated.

TABLE 6

| | | Expression suppression |
|---|---|---|
| | | ratio of proinflammatory |
| Classification | Note | cytokine (%) |
| Example 9 | 633 ± 5 nm/5 μW/cm² | 19.7 |
| Example 10 | 633 ± 5 nm/47.5 μW/cm² | 53.2 |
| Comparative | Positive control group | 41.1 |
| Example 12 | (ketoprofen) | |

It can be confirmed that the display devices of the present Examples (Examples 9 and 10) have the expression suppression effect of proinflammatory cytokine by the ultraviolet rays and the expression suppression ratio of proinflammatory cytokine is increased as the intensity of red light is increased. Particularly, Example 10, exhibits the higher expression suppression ratio of proinflammatory cytokine as compared to the positive control group.

While this disclosure has been described in connection with what is presently considered to be practical example embodiments, it is to be understood that the disclosure is not limited to the disclosed embodiments, but, on the contrary, is intended to cover various modifications and equivalent arrangements included within the scope of the appended claims, detailed description of the disclosure, and drawings.

<Description of symbols>

| | |
|---|---|
| 10: Substrate | 20: Display unit |
| 30: Controller | 211: Pixel electrode |
| 212: Common electrode | 213: Light emitting layer |
| 214: Pixel definition layer | 215: Hole transport layer |
| 216: Electron transport layer | 217: Electron injection layer |
| 218: Capping layer | |

What is claimed is:

1. A display device comprising:
a substrate; and
a display unit formed on the substrate and including a red pixel, a green pixel, and a blue pixel,
wherein the red pixel emits red light having a peak wavelength of 628 nm to 638 nm.

2. The display device of claim 1, wherein:
a full width at half maximum of the red light is 1 nm or more and 40 nm or less.

3. The display device of claim 1, further comprising:
a controller configured to supply a driving signal to the display unit,
wherein the controller has a mode change function configured to select at least one of a display mode and a phototherapy mode.

4. The display device of claim 3, wherein:
when the display mode is selected, the driving signal is supplied to the red pixel, the green pixel, and the blue pixel, and
when the phototherapy mode is selected, the driving signal is supplied to only the red pixel.

5. The display device of claim 3, wherein:
the controller is configured to calculate a required use time corresponding to a recommended daily allowance of light exposure when the phototherapy mode is selected, compare the required use time and an actual use time, and if the actual use time satisfies the required use time, automatically finish the phototherapy mode.

6. The display device of claim 5, wherein:
the controller is configured to inform a user of a residual use time corresponding to a difference between the required use time and the actual use time in a voice information or visual information form.

7. The display device of claim 1, wherein:
each of the red pixel, the green pixel, and the blue pixel includes:
a thin film transistor formed on the substrate;
a pixel electrode connected to the thin film transistor;
a light emitting layer formed on the pixel electrode; and
a common electrode formed on the light emitting layer.

8. The display device of claim 7, wherein:
the pixel electrode is formed of a metal reflection layer and the common electrode is formed of a transflective layer to form a resonance structure.

9. The display device of claim 8, wherein:
the pixel electrode is formed of a double layer of the metal reflection layer and a transparent conductive layer.

10. The display device of claim 8, wherein:
a capping layer is formed on the common electrode.

11. The display device of claim 8, wherein:
the pixel electrode is formed of the double layer of the transparent conductive layer and the transflective layer and the common electrode is formed of the metal reflection layer to form the resonance structure.

12. A phototherapy method using a display device, comprising:
exposing a portion of skin cells to red light by using the display device, the display device including a red pixel emitting the red light having a peak wavelength of 628 nm to 638 nm.

13. The phototherapy method of claim 12, wherein:
an intensity of the red light is 1 μW/cm² or more and 100 μW/cm² or less.
